(19) United States
(12) Patent Application Publication
(10) Pub. No.: US 2011/0128935 A1
(43) Pub. Date: Jun. 2, 2011

(54) APPARATUS AND METHOD FOR HANDOVER OF MS IN WIRELESS COMMUNICATION SYSTEM

(75) Inventors: Jae-Hyuk JANG, Suwon-si (KR); Jung-Je SON, Yongin-si (KR)

(73) Assignee: SAMSUNG ELECTRONICS CO. LTD., Suwon-si (KR)

(21) Appl. No.: 12/954,754

(22) Filed: Nov. 26, 2010

(30) Foreign Application Priority Data
Nov. 30, 2009 (KR) 10-2009-0117160

(51) Int. Cl. H04W 36/00

(52) U.S. Cl. 370/331

(57) ABSTRACT

An apparatus and method for handover of a Mobile Station (MS) in a wireless communication system are provided. The method includes, if a ranging request signal is received from the MS attempting access through a handover, determining if the BS and a serving BS of the MS are the same BS based on the ranging request signal, and, if the BS and the serving BS are the same BS, determining the effectiveness of a Cipher-based Message Authentication Code (CMAC) included in the ranging request signal using previous authentication information of the MS. The serving BS denotes a BS from which the MS has been serviced before the handover. The previous authentication information of the MS denotes authentication information that the serving BS has used for authenticating the MS.

### PRIORITY

This application claims the benefit under 35 U.S.C. §119(a) of a Korean patent application filed in the Korean Intellectual Property Office on Nov. 30, 2009 and assigned Serial No. 10-2009-0117160, the entire disclosure of which is herein incorporated by reference.

### BACKGROUND OF THE INVENTION

1. Field of the Invention

The present invention relates to an apparatus and method for handover of a Mobile Station (MS) in a wireless communication system. More particularly, the present invention relates to an apparatus and method for handover of an MS within a multi carrier Base Station (BS) in a wireless communication system.

2. Description of the Related Art

Wireless communication systems support handover to guarantee the mobility of Mobile Stations (MSs). For example, in a case where an MS is to perform handover from a serving BS to a target BS, the MS sends the target BS a RaNGing REQuest signal (RNG-REQ) including a Cipher-based Message Authentication Code (CMAC) to access the target BS. The target BS receives authentication information of the MS from an authenticator, and determines if the CMAC of the MS is correct.

In a case where multi carriers are supported, a BS and an MS can perform communication using a plurality of carriers. In this case, a single carrier MS can perform handover between frequencies of the multi carrier BS. For example, in a case where the multi carrier BS services a frequency 1, a frequency 2, and a frequency 3, the single carrier MS can perform handover from the frequency 1 to the frequency 3. However, a scheme of handover of an MS between frequencies supported by one BS has not been defined.

Accordingly, in a case where the MS is to perform handover between serving and target frequencies supported by one BS, the MS performs the handover by recognizing the serving and target frequencies of the BS as being provided by different BSs. Also, in order to again determine a CMAC of the MS, the BS again receives authentication information on the already authenticated MS from the authenticator, thereby causing a problem of incurring an unnecessary handover delay.

### SUMMARY OF THE INVENTION

An aspect of the present invention is to address at least the above-mentioned problems and/or disadvantages and to provide at least the advantages below. Accordingly, one aspect of the present invention is to provide an apparatus and method for reducing a handover delay of a Mobile Station (MS) in a wireless communication system.

Another aspect of the present invention is to provide an apparatus and method for handover of an MS within a multi carrier Base Station (BS) in a wireless communication system.

A further aspect of the present invention is to provide an apparatus and method for an MS to compare IDentifier (ID) information of a serving BS with ID information of a target BS and determine if a handover is an intra-BS handover in a wireless communication system.

Yet another aspect of the present invention is to provide an apparatus and method for comparing an ID of a serving BS of an MS performing handover with an ID of a multi carrier BS and determining if a handover is an intra-BS handover within the multi carrier BS of a wireless communication system.

A still another aspect of the present invention is to provide an apparatus and method for, in a case where an MS is to perform intra-BS handover, determining if the MS is accessible using previous authentication information on the MS in a multi carrier BS of a wireless communication system.

The above aspects are addressed by providing an apparatus and method for handover of an MS in a wireless communication system.

According to one aspect of the present invention, a method for supporting handover of a Mobile Station (MS) in a multi carrier Base Station (BS) of a wireless communication system is provided. The method includes, if a ranging request signal is received from the MS attempting access through a handover, determining if the BS and a serving BS of the MS are the same BS based on the ranging request signal and, if the BS and the serving BS are the same BS, determining the effectiveness of a Cipher-based Message Authentication Code (CMAC) included in the ranging request signal using previous authentication information of the MS. The serving BS denotes a BS from which the MS has been serviced before the handover. The previous authentication information of the MS denotes authentication information that the serving BS has used for authenticating the MS.

According to another aspect of the present invention, a method for handover of an MS in a wireless communication system is provided. The method includes, when the MS is to perform handover from a serving BS to a target BS, determining if the serving BS and the target BS are the same BS, generating a CMAC using authentication information having been used for communication with the serving BS if the serving BS and the target BS are the same BS, and transmitting a ranging request signal including the CMAC and information representing that the serving BS and the target BS are the same BS, to the target BS.

According to a further aspect of the present invention, an apparatus for supporting handover of an MS in a multi carrier BS of a wireless communication system is provided. The apparatus includes a receiving unit for receiving a signal, a BS determining unit for, if a ranging request signal is received from the MS attempting access through a handover, determining if the BS and a serving BS of the MS are the same BS based on the ranging request signal, and a controller for, if the BS and the serving BS are the same BS, determining the effectiveness of a CMAC included in the ranging request signal using previous authentication information of the MS. The serving BS denotes a BS from which the MS has been serviced before the handover. The previous authentication information of the MS denotes authentication information that the serving BS has used for authenticating the MS.

According to a yet another aspect of the present invention, an apparatus for handover of an MS in a wireless communication system is provided. The apparatus includes a BS determining unit for, when the MS is to perform handover from a serving BS to a target BS, determining if the serving BS and the target BS are the same BS, and a transmitting unit for, if the serving BS and the target BS are the same BS, generating a CMAC using authentication information having been used for communication with the serving BS, and for transmitting a ranging request signal including the CMAC and information representing that the serving BS and the target BS are the same BS, to the target BS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a ladder diagram illustrating a handover procedure of a Mobile Station (MS) in a wireless communication system according to an exemplary embodiment of the present invention;

FIG. 2 is a flow diagram illustrating a procedure for an MS to access a target Base Station (BS) according to an exemplary embodiment of the present invention;

FIG. 3 is a flow diagram illustrating a procedure of authenticating an MS in a BS according to an exemplary embodiment of the present invention;

FIG. 4 is a ladder diagram illustrating a handover procedure of an MS in a wireless communication system according to an exemplary embodiment of the present invention;

FIG. 5 is a flow diagram illustrating a procedure for accessing a target BS in an MS according to an exemplary embodiment of the present invention;

FIG. 6 is a flow diagram illustrating a procedure for authenticating an MS in a BS according to an exemplary embodiment of the present invention;

FIG. 7 is a block diagram illustrating a construction of an MS according to an exemplary embodiment of the present invention; and

FIG. 8 is a block diagram illustrating a construction of a BS according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for supporting inter-frequency handover within a multi carrier Base Station (BS) in a wireless communication system. Here, the inter-frequency handover within the multi carrier BS denotes handover of a Mobile Station (MS) between frequencies at which the multi carrier BS provides a service.

In the following description, in a case where a BS supports multi carriers, a serving BS denotes the BS managing a first frequency, and a target BS denotes the BS managing a second frequency. Here, the first frequency denotes a frequency at which an MS has been serviced before performing handover to the target BS, and the second frequency denotes a new frequency at which the MS accesses through handover.

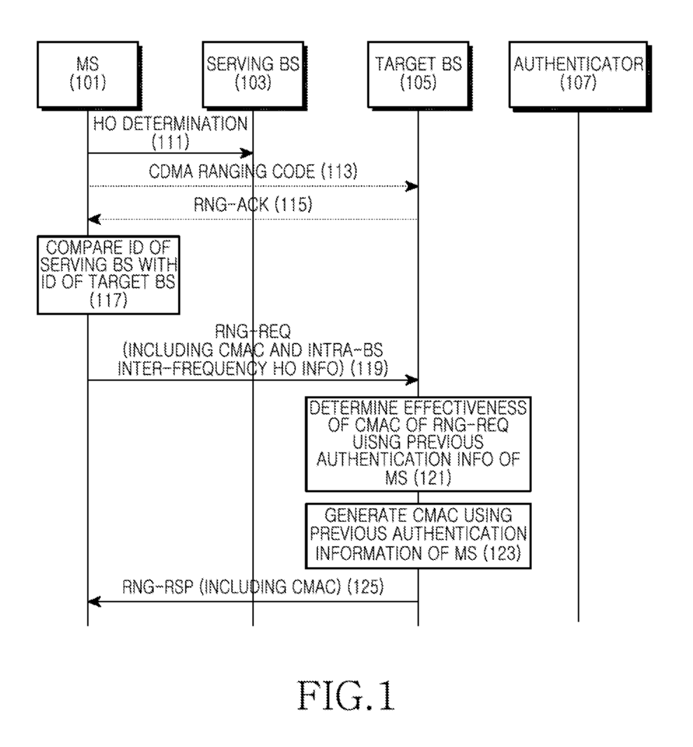

FIG. 1 illustrates a handover procedure of an MS in a wireless communication system according to an exemplary embodiment of the present invention. In FIG. 1, signaling indicated by a dotted line represents omissible signaling, and signaling indicated by a solid line represents non-omissible signaling.

Referring to FIG. 1, the wireless communication system includes an MS 101, a serving BS 103, a target BS 105, and an authenticator 107.

In a case where the MS 101 is to perform a HandOver (HO) from the serving BS 103 to the target BS 105 in step 111, the MS 101 transmits a ranging code (i.e., a Code Division Multiple Access (CDMA) ranging code) to the target BS 105 in step 113 to acquire synchronization with the target BS 105. At this time, the description of a series of processes in which the MS 101 determines the handover from the serving BS 103 to the target BS 105 is omitted for brevity.

In step 115, the target BS 105 transmits a RaNGing code ACKnowledgement (RNG-ACK) signal to the MS 101 such that the MS 101 acquires synchronization with the target BS 105 by itself according to the CDMA ranging code. The MS 101 acquires synchronization with the target BS 105 using the RNG-ACK signal.

After acquiring synchronization with the target BS 105, in step 117, the MS 101 determines if the serving BS 103 and the target BS 105 are the same BS. For example, the MS 101 compares an IDentifier (ID) of the serving BS 103 with an ID of the target BS 105 and determines if the two BSs are the same BS. In another example, the MS 101 can determine if the two BSs are the same BS through a neighbor BS information message (i.e., a NeighBoR ADVertisement (NBR-ADV) message) received from the serving BS 103. In a further example, the MS 101 may determine if the two BSs are the same BS through a multi carrier information message (i.e., a Multi-Carrier ADVertisement (MC-ADV) message) received from the serving BS 103. In yet another example, the MS 101 may determine if the two BSs are the same BS through a carrier configuration information message (i.e., a Carrier Configuration ADVertisement (CC-ADV) message) received from the serving BS 103.

If the serving BS 103 and the target BS 105 are the same BS, the MS 101 recognizes that it is to perform intra-BS inter-frequency handover. Accordingly, in step 119, the MS 101 transmits a RaNGing REQuest (RNG-REQ) signal including both intra-BS inter-frequency handover information and a message authentication code (i.e., a Cipher-based Message Authentication Code (CMAC)), to the target BS 105. For example, the MS 101 adds the intra-BS inter-frequency handover information to the RNG-REQ signal using a ranging purpose indication field of the RNG-REQ signal. At this time, the MS 101 can add the intra-BS inter-frequency handover information to the RNG-REQ signal using the last bit of the ranging purpose indication field.

The target BS 105 determines if the MS 101 is to perform the intra-BS inter-frequency handover from the RNG-REQ signal. For example, the target BS 105 determines if the MS 101 is to perform the intra-BS inter-frequency handover through the ranging purpose indication field value of the RNG-REQ signal.

If the MS 101 is to perform the intra-BS inter-frequency handover, in step 121, the target BS 105 determines the effectiveness of the CMAC included in the RNG-REQ signal using previous authentication information of the MS 101. That is, the target BS 105 determines the effectiveness of the CMAC for the MS 101 using an AK that the serving BS 103 has received from the authenticator 107 to authenticate the MS 101. Here, the previous authentication information of the MS 101 denotes authentication information having been used when the serving BS 103 authenticates the MS 101. Also, the authentication information includes AK information (i.e., an AK context).

If the CMAC of the MS 101 included in the RNG-REQ signal is effective, in step 123, the target BS 105 generates a CMAC using the previous authentication information of the MS 101.

After that, in step 125, the target BS 105 transmits a RaNGing ReSPonse (RNG-RSP) signal including the CMAC generated in step 123, to the MS 101. In this case, the MS 101 can determine the target BS 105 through the CMAC included in the RNG-RSP signal.

As described above, if the serving BS 103 and the target BS 105 are the same BS, the MS 101 transmits a RNG-REQ signal including intra-BS inter-frequency handover information and a CMAC to the target BS 105. At this time, the RNG-REQ signal includes the CMAC generated using the authentication information that the MS 101 has used for communication with the serving BS 103.

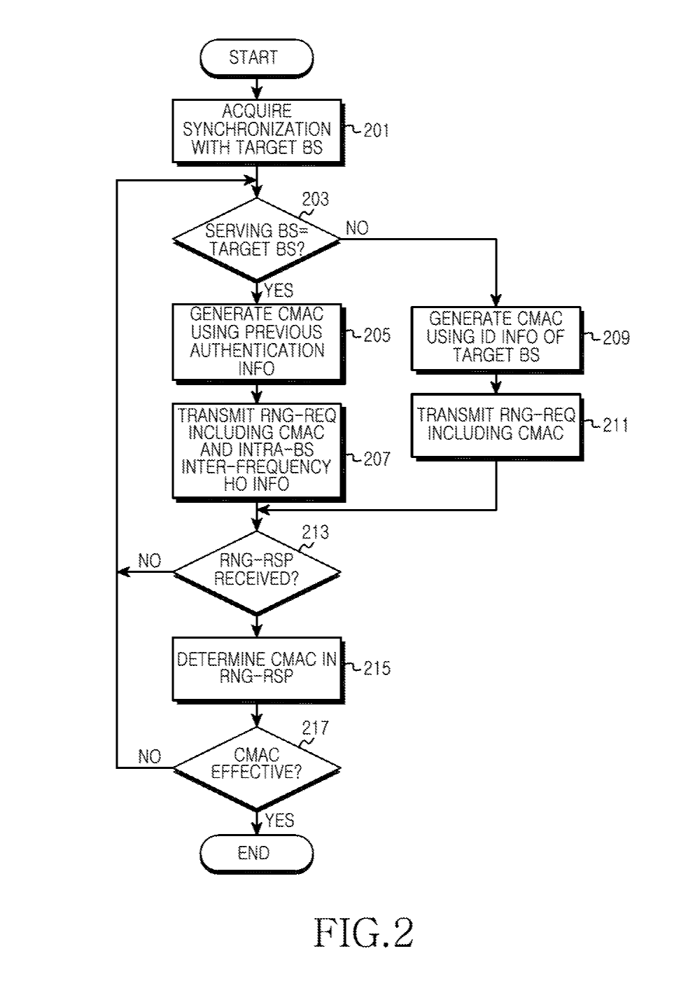

FIG. 2 illustrates a procedure for an MS to access a target BS according to an exemplary embodiment of the present invention.

Referring to FIG. 2, in a case where an MS is to perform handover from a serving BS to a target BS, in step 201, the MS acquires synchronization with the target BS. That is, the MS transmits a ranging code to the target BS and acquires synchronization with the target BS.

After that, the MS proceeds to step 203 and determines if the serving BS and the target BS are the same BS. For example, the MS compares an ID of the serving BS with an ID of the target BS and determines if the two BSs are the same BS. In another example, the MS can determine if the two BSs are the same BS through a neighbor BS information message (i.e., a NBR-ADV message) received from the serving BS. In a further example, the MS may determine if the two BSs are the same BS through a multi carrier information message (i.e., a MC-ADV message) received from the serving BS. In yet another example, the MS may determine if the two BSs are the same BS through a carrier configuration information message (i.e., a CC-ADV message) received from the serving BS.

If the serving BS and the target BS are the same BS in step 203, the MS recognizes that it is to perform intra-BS inter-frequency handover. Accordingly, the MS proceeds to step 205 and generates a CMAC using authentication information having been used for communication with the serving BS.

After generating the CMAC in step 205, the MS proceeds to step 207 and transmits a RNG-REQ signal including both the CMAC and intra-BS inter-frequency handover information, to the target BS. For example, the MS adds the intra-BS inter-frequency handover information to the RNG-REQ signal using a ranging purpose indication field of the RNG-REQ signal. At this time, the MS can add the intra-BS inter-frequency handover information to the RNG-REQ signal using the last bit of the ranging purpose indication field.

On the other hand, if the serving BS and the target BS are not the same BS in step 203, the MS proceeds to step 209 and generates a CMAC based on the ID of the target BS.

After generating the CMAC in step 209, the MS proceeds to step 211 and transmits a RNG-REQ signal including the CMAC to the target BS.

After transmitting the RNG-REQ signal to the target BS in step 207 or step 211, the MS proceeds to step 213 and determines if a RNG-RSP signal is received from the target BS.

If the RNG-RSP signal is not received from the target BS within a reference time in step 213, the MS recognizes that the transmission of the RNG-REQ signal has failed. Accordingly, the MS returns to step 203 and again generates a CMAC to again transmit a RNG-REQ signal. For example, because a variable used for generating a CMAC is different depending on performance or non-performance of intra-BS inter-frequency handover, in step 203, the MS determines that it is to perform the intra-BS inter-frequency handover. In another example, in a case where the MS transmits the RNG-REQ signal to the target BS in step 207, the MS can proceed to step 205 and generate a CMAC. In a further example, in a case where the MS transmits the RNG-REQ signal to the target BS in step 211, the MS may proceed to step 209 and generate a CMAC. In yet another example, the MS may terminate the retransmission of the RNG-REQ signal in consideration of the number of times the RNG-REQ signal has been transmitted.

On the other hand, if the RNG-RSP signal is received from the target BS in step 213, the MS proceeds to step 215 and determines a CMAC in the RNG-RSP signal received from the target BS.

After that, the MS proceeds to step 217 and determines the effectiveness of the CMAC determined in the RNG-RSP signal.

If the CMAC determined in the RNG-RSP signal is not effective, the MS returns to step 203 and again generates a CMAC to again transmit a RNG-REQ signal. For example, because a variable used for generating a CMAC is different depending on performance or non-performance of intra-BS inter-frequency handover, in step 203, the MS determines that it is to perform the intra-BS inter-frequency handover. In another example, in a case where the MS transmits the RNG-REQ signal to the target BS in step 207, the MS can proceed to step 205 and generate a CMAC. In a further example, in a case where the MS transmits the RNG-REQ signal to the target BS in step 211, the MS may proceed to step 209 and generate a CMAC. In yet another example, the MS may terminate the retransmission of the RNG-REQ signal in consideration of the number of times the RNG-REQ signal has been transmitted.

On the other hand, in a case where the CMAC determined in the RNG-RSP signal is effective in step 217, the MS terminates the procedure according to the exemplary embodiment of the present invention. That is, the MS terminates handover to the target BS.

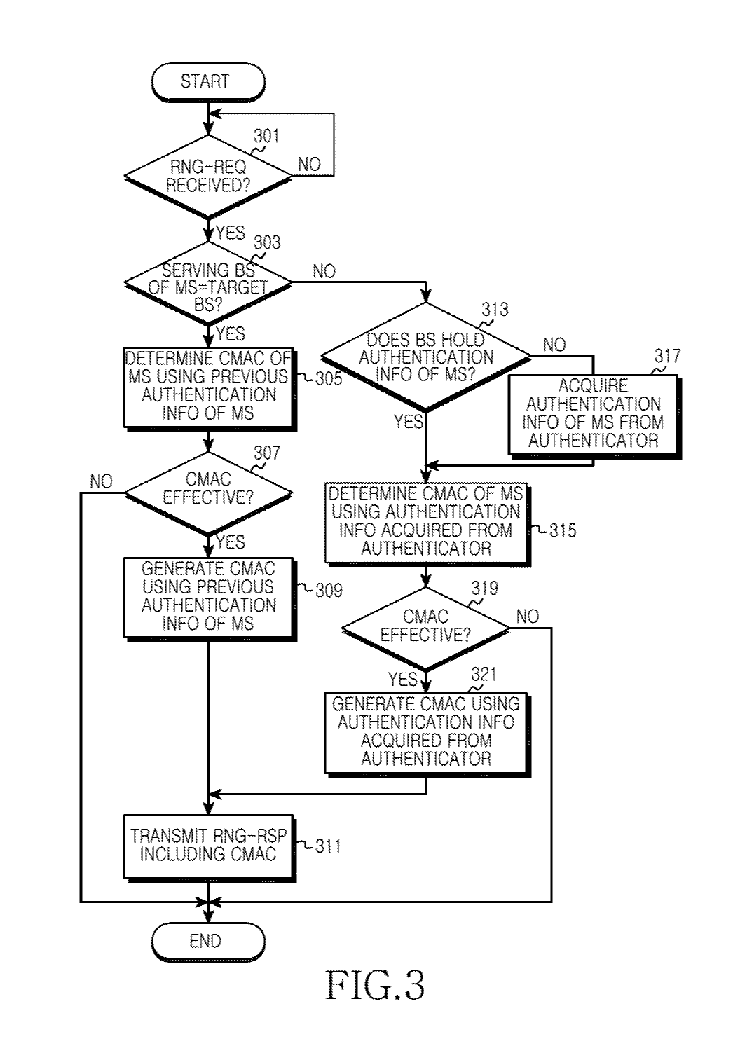

As described above, in a case where an MS transmits intra-BS inter-frequency handover information to a target BS, the target BS can authenticate the MS as described below with reference to FIG. 3.

FIG. 3 is a flow diagram illustrating a procedure of authenticating an MS in a BS according to an exemplary embodiment of the present invention.

Referring to FIG. 3, in step 301, the BS determines if a RNG-REQ signal is received from an MS.

If the RNG-REQ signal is received from the MS, the BS proceeds to step 303 and determines if the MS is to perform intra-BS inter-frequency handover based on the RNG-REQ signal. That is, the BS determines if it and a serving BS of the MS performing handover are the same BS. For example, the BS determines if the MS is to perform the intra-BS inter-frequency handover based on a ranging purpose indication field value of the RNG-REQ signal.

If the MS is to perform the intra-BS inter-frequency handover, the BS recognizes that it and the serving BS of the MS are the same BS. Accordingly, the BS proceeds to step 305 and determines the effectiveness of a CMAC included in the RNG-REQ signal using previous authentication information of the MS. That is, the BS determines the effectiveness of the CMAC using an AK that the serving BS has received from a network to authenticate the MS. Here, the previous authentication information of the MS denotes authentication information having been used when the serving BS of the MS authenticates the MS. Also, the authentication information includes AK information (i.e., an AK context).

At this time, the BS proceeds to step 307 and determines if the CMAC included in the RNG-REQ signal is effective according to the effectiveness determined in step 305.

If the CMAC included in the RNG-REQ signal is not effective in step 307, the BS terminates the procedure according to the exemplary embodiment of the present invention.

If the CMAC of the MS included in the RNG-REQ signal is effective in step 307, the BS proceeds to step 309 and generates a CMAC using the previous authentication information of the MS.

After that, the BS proceeds to step 311 and transmits a RNG-RSP signal including the CMAC generated in step 309, to the MS.

On the other hand, if the MS is not to perform the intra-BS inter-frequency handover in step 303, the BS recognizes that it and the serving BS of the MS are different BSs. Accordingly, the BS proceeds to step 313 and determines if it holds authentication information on the MS. That is, the BS determines if it has acquired the authentication information of the MS from an authenticator before receiving the RNG-REQ signal of the MS.

If the BS holds the authentication information on the MS in step 313, the BS recognizes that it has acquired the authentication information of the MS from the authenticator before receiving the RNG-REQ signal of the MS. Accordingly, the BS proceeds to step 315 and determines the effectiveness of the CMAC included in the RNG-REQ signal using the authentication information on the MS.

On the other hand, if the BS does not hold the authentication information on the MS in step 313, the BS proceeds to step 317 and acquires the authentication information on the MS from the authenticator.

Accordingly, the BS proceeds to step 315 and determines the effectiveness of the CMAC included in the RNG-REQ signal using previous authentication information on the MS acquired from the authenticator.

At this time, the BS proceeds to step 319 and determines if the CMAC included in the RNG-REQ signal is effective according to the effectiveness determined in step 315.

If the CMAC included in the RNG-REQ signal is not effective in step 319, the BS terminates the procedure according to the exemplary embodiment of the present invention.

If the CMAC of the MS included in the RNG-REQ signal is effective in step 319, the BS proceeds to step 321 and generates a CMAC using the previous authentication information of the MS acquired from the authenticator.

After generating the CMAC, the BS proceeds to step 311 and transmits a RNG-RSP signal including the CMAC generated in step 309, to the MS.

After that, the BS terminates the procedure according to the exemplary embodiment of the present invention. That is, the BS terminates handover for the MS.

In the aforementioned exemplary embodiment, a target BS determines if an MS is to perform intra-BS inter-frequency handover in a RNG-REQ signal received from the MS.

In another exemplary embodiment, a target BS can compare its own ID with an ID of a serving BS of an MS and determine if the MS is to perform intra-BS inter-frequency handover.

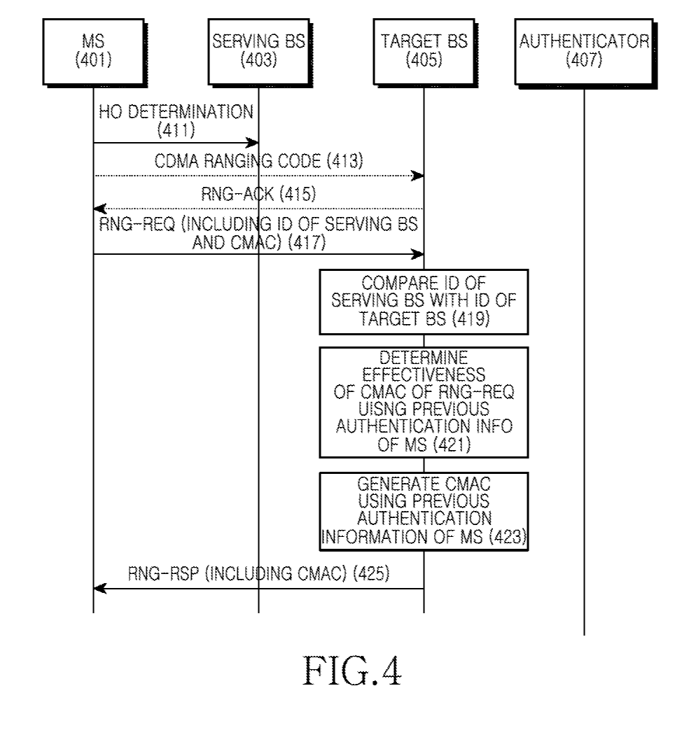

FIG. 4 illustrates a handover procedure of an MS in a wireless communication system according to an exemplary embodiment of the present invention. In FIG. 4, signaling indicated by a dotted line represents omissible signaling, and signaling indicated by solid line represents non-omissible signaling.

Referring to FIG. 4, the wireless communication system includes an MS 401, a serving BS 403, a target BS 405, and an authenticator 407.

In a case where the MS 401 is to perform handover from the serving BS 403 to the target BS 405 in step 411, the MS 401 transmits a ranging code (i.e., a CDMA ranging code) to the target BS 405 in step 413 to acquire synchronization with the target BS 405. At this time, a description of a series of processes in which the MS 401 determines the handover from the serving BS 403 to the target BS 405 is omitted for brevity.

In step 415, the target BS 405 transmits a RNG-ACK signal to the MS 401 such that the MS 401 can acquire synchronization with the target BS 405 by itself according to the CDMA ranging code. The MS 401 acquires synchronization with the target BS 405 using the RNG-ACK signal.

After acquiring synchronization with the target BS 405, in step 417, the MS 401 transmits a RNG-REQ signal including a CMAC and ID information of the serving BS 403, to the target BS 405. For example, the MS 401 adds an ID of the serving BS 403 to a ranging purpose indication field of the RNG-REQ signal. Also, the MS 401 adds a CMAC, which is generated based on the ID information of the target BS 405, to the RNG-REQ signal.

The target BS 405 determines the ID of the serving BS 403 of the MS 401 in the RNG-REQ signal. For example, the target BS 405 determines the ID of the serving BS 403 of the MS 401 in the ranging purpose indication field of the RNG-REQ signal.

After that, in step 419, the target BS 405 compares its own ID with the ID of the serving BS 403 and determines if itself and the serving BS 403 are the same BS.

If the serving BS 403 and the target BS 405 are the same BS, the target BS 405 determines if the MS 401 is to perform intra-BS inter-frequency handover. Accordingly, in step 421, the target BS 405 determines the effectiveness of a CMAC included in the RNG-REQ signal using previous authentication information of the MS 401. That is, the target BS 405 determines the effectiveness of the CMAC for the MS 401 using an AK that the serving BS 403 has received from the authenticator 407 to authenticate the MS 401. Here, the previous authentication information of the MS 401 denotes authentication information having been used when the serving BS 403 authenticates the MS 401. Also, the authentication information includes AK information (i.e., an AK context).

If the CMAC of the MS 401 included in the RNG-REQ signal is effective, in step 423, the target BS 405 generates a CMAC using the previous authentication information of the MS 401.

After that, in step 425, the target BS 405 transmits a RNG-RSP signal including the generated CMAC, to the MS 401.

The MS 401 can determine the target BS 405 through the CMAC included in the RNG-RSP signal.

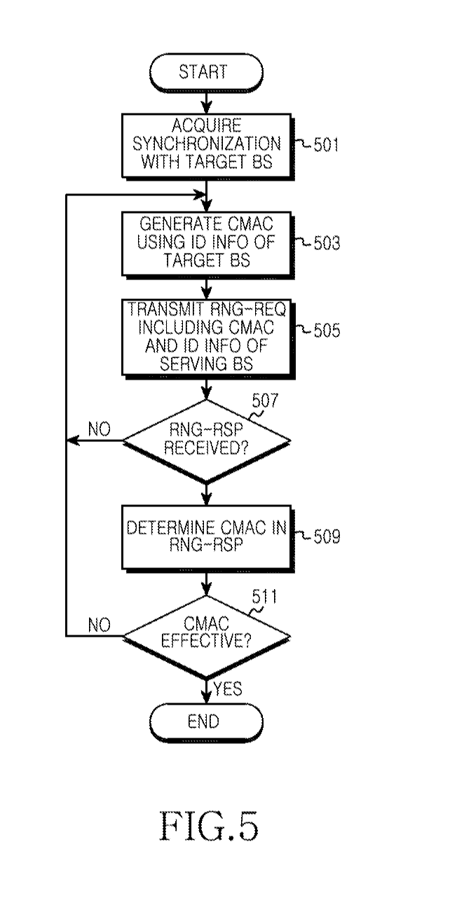

FIG. 5 illustrates a procedure for accessing a target BS in an MS according to an exemplary embodiment of the present invention.

Referring to FIG. 5, in a case where an MS is to perform handover from a serving BS to a target BS, in step 501, the MS acquires synchronization with the target BS. That is, the MS transmits a ranging code to the target BS and acquires synchronization with the target BS.

After that, the MS proceeds to step 503 and generates a CMAC based on the ID of the target BS.

After generating the CMAC, the MS proceeds to step 505 and transmits a RNG-REQ signal including the CMAC and ID information of the serving BS to the target BS. For example, the MS adds an ID of the serving BS to a ranging purpose indication field of the RNG-REQ signal.

After that, the MS proceeds to step 507 and determines if a RNG-RSP signal is received from the target BS.

If the RNG-RSP signal is not received from the target BS within a reference time in step 507, the MS recognizes that the transmission of the RNG-REQ signal has failed. Accordingly, the MS proceeds to step 503 and again generates a CMAC to again transmit a RNG-REQ signal. At this time, the MS may terminate the retransmission of the RNG-REQ signal in consideration of the number of times the RNG-REQ signal has been transmitted.

On the other hand, if the RNG-RSP signal is received from the target BS in step 507, the MS proceeds to step 509 and determines a CMAC in the RNG-RSP signal received from the target BS.

After that, the MS proceeds to step 511 and determines the effectiveness of the CMAC determined in the RNG-RSP signal.

If the CMAC determined in the RNG-RSP signal is not effective in step 511, the MS returns to step 503 and again generates a CMAC to again transmit a RNG-REQ signal. At this time, the MS may terminate the retransmission of the RNG-REQ signal in consideration of the number of times the RNG-REQ signal has been transmitted.

On the other hand, if the CMAC determined in the RNG-RSP signal is effective in step 511, the MS terminates the procedure according to the exemplary embodiment of the present invention. That is, the MS terminates handover to the target BS.

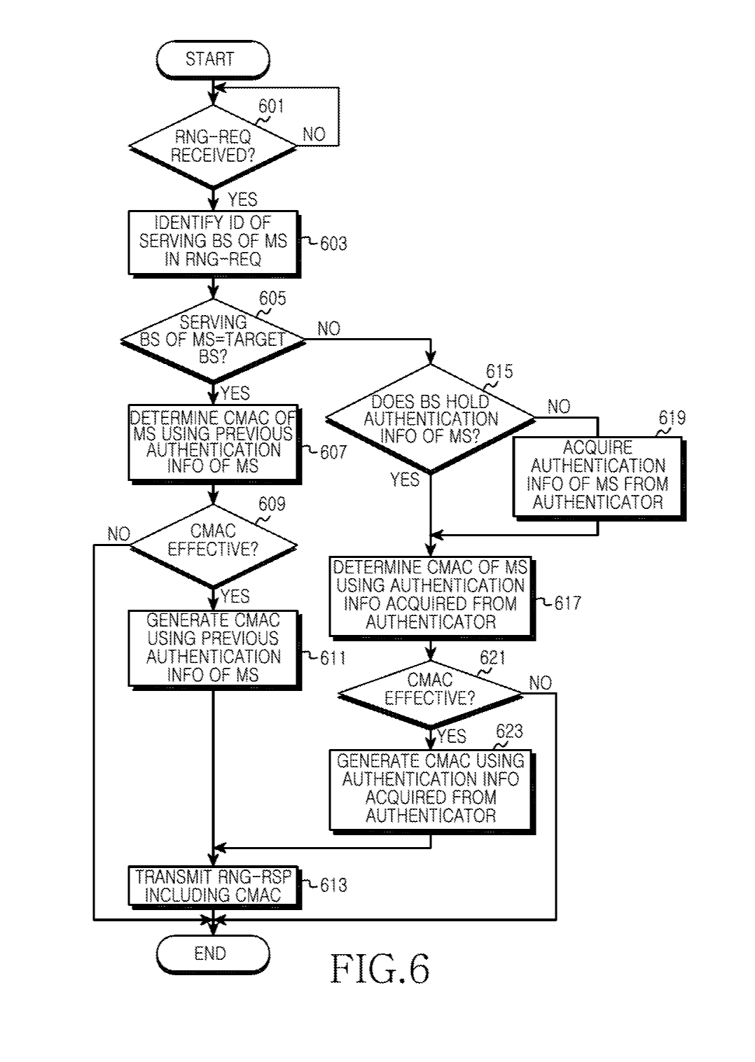

As described above, in a case where an MS transmits ID information of a serving BS to a target BS, the target BS can authenticate the MS as described below with reference to FIG. 6.

FIG. 6 illustrates a procedure for authenticating an MS in a BS according to an exemplary embodiment of the present invention.

Referring to FIG. 6, in step 601, the BS determines if a RNG-REQ signal is received from an MS.

If the RNG-REQ signal is received from the MS, the BS proceeds to step 603 and determines an ID of a serving BS of the MS in the RNG-REQ signal. For example, the BS determines the ID of the serving BS of the MS in a ranging purpose indication field of the RNG-REQ signal.

After that, the BS proceeds to step 605 and compares its own ID with the ID of the serving BS of the MS and determines if itself and the serving BS of the MS are the same BS.

If the BS determines that it and the serving BS of the MS are the same BS, the BS recognizes that the MS is to perform intra-BS inter-frequency handover. Accordingly, the BS proceeds to step 607 and determines the effectiveness of a CMAC included in the RNG-REQ signal using previous authentication information of the MS. That is, the BS determines the effectiveness of the CMAC for the MS using an AK that the serving BS has received from a network to authenticate the MS. Here, the previous authentication information of the MS denotes authentication information having been used when the serving BS of the MS authenticates the MS. Also, the authentication information includes AK information (i.e., an AK context).

At this time, the BS proceeds to step 609 and detrermines if the CMAC included in the RNG-REQ signal is effective according to the effectiveness determined in step 607.

If the CMAC included in the RNG-REQ signal is not effective in step 609, the BS terminates the procedure according to the exemplary embodiment of the present invention.

If the CMAC included in the RNG-REQ signal is effective in step 609, the BS proceeds to step 611 and generates a CMAC using the previous authentication information of the MS.

After that, the BS proceeds to step 613 and transmits a RNG-RSP signal including the CMAC to the MS.

On the other hand, if the BS determines that it and the serving BS of the MS are different BSs in step 605, the BS recognizes that the MS is not to perform the intra-BS inter-frequency handover. Accordingly, the BS proceeds to step 615 and determines if it holds authentication information on the MS. That is, the BS determines if it has acquired the authentication information of the MS from an authenticator before receiving the RNG-REQ signal of the MS.

If the BS holds the authentication information on the MS in step 615, the BS recognizes that it has acquired the authentication information of the MS from the authenticator before receiving the RNG-REQ signal of the MS. Accordingly, the BS proceeds to step 617 and determines the effectiveness of the CMAC included in the RNG-REQ signal using the authentication information on the MS acquired from the authenticator.

On the other hand, if the BS does not hold the authentication information on the MS in step 615, the BS proceeds to step 619 and acquires the authentication information on the MS from the authenticator.

After that, the BS proceeds to step 617 and determines the effectiveness of the CMAC included in the RNG-REQ signal using the previous authentication information of the MS acquired from the authenticator.

At this time, the BS proceeds to step 621 and determines if the CMAC included in the RNG-REQ signal is effective according to the effectiveness determined in step 617.

If the CMAC included in the RNG-REQ signal is not effective in step 621, the BS terminates the procedure according to the exemplary embodiment of the present invention.

On the other hand, if the CMAC of the MS included in the RNG-REQ signal is effective in step 621, the BS proceeds to step 623 and generates a CMAC using the previous authentication information of the MS acquired from the authenticator.

After generating the CMAC, the BS proceeds to step 613 and transmits a RNG-RSP signal including the generated CMAC to the MS.

Next, the BS terminates the procedure according to the exemplary embodiment of the present invention. That is, the BS terminates handover for the MS.

The following description is made for a construction of an MS for performing handover. The following description assumes that the MS uses an Orthogonal Frequency-Division Multiplexing (OFDM) scheme.

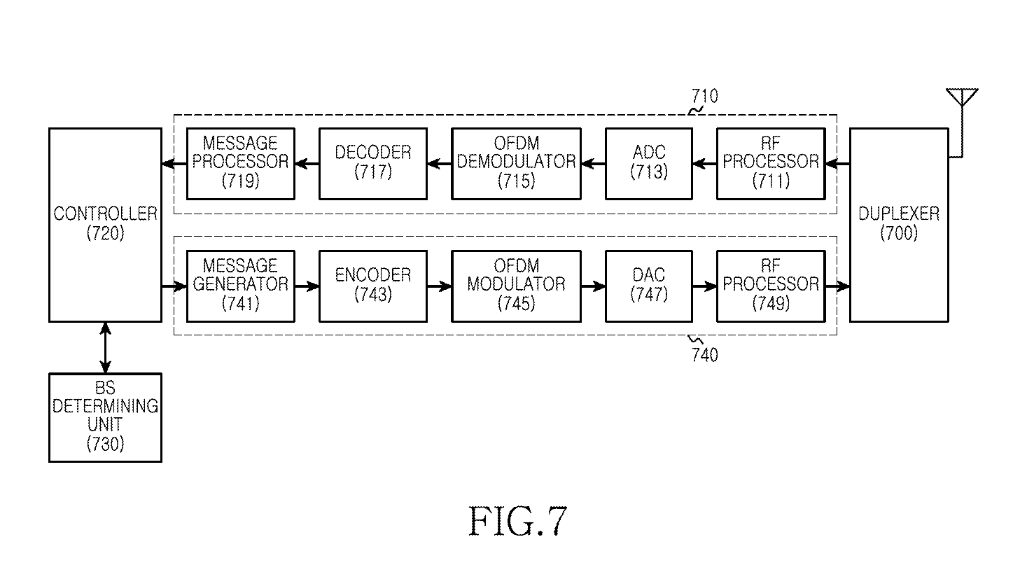

FIG. 7 illustrates a construction of an MS according to an exemplary embodiment of the present invention.

Referring to FIG. 7, the MS includes a duplexer 700, a receiving unit 710, a controller 720, a BS determining unit 730, and a transmitting unit 740.

According to a duplexing scheme, the duplexer 700 transmits a transmit signal received from the transmitting unit 740 through an antenna, and provides a receive signal from the antenna to the receiving unit 710.

The receiving unit 710 includes a Radio Frequency (RF) processor 711, an Analog to Digital Converter (ADC) 713, an OFDM demodulator 715, a decoder 717, and a message processor 719.

The RF processor 711 converts a high frequency signal provided from the duplexer 700 into a baseband analog signal. The ADC 713 converts the analog signal provided from the RF processor 711 into digital sample data.

The OFDM demodulator 715 converts time-domain digital sample data provided from the ADC 713 into frequency-domain data through a Fast Fourier Transform (FFT).

The decoder 717 selects data of subcarriers intended for actual reception among the frequency-domain data provided from the OFDM demodulator 715. After that, the decoder 717 demodulates and decodes the selected data according to a predefined modulation level. Here, the modulation level includes a Modulation and Coding Scheme (MCS).

The message processor 719 extracts control information from a signal provided from the decoder 717 and transmits the control information to the controller 720. For example, the message processor 719 extracts a CMAC generated by a target BS from a ranging response signal provided from the decoder 717, and transmits the extracted CMAC to the controller 720.

The controller 720 controls handover of the MS. For example, the controller 720 determines if the MS will perform handover. At this time, the controller 720 may determine the target BS which the MS will perform handover to.

The controller 720 controls and performs intra-BS inter-frequency handover depending on an identity or non-identity between a serving BS and the target BS provided from the BS determining unit 730. For example, in a case where the serving BS from which the MS receives a service and the target BS to which the MS is to perform handover are the same BS, the controller 720 controls to transmit intra-BS inter-frequency handover information to the target BS.

The BS determining unit 730 determines if the serving BS of the MS and the target BS are the same BS. For example, the BS determining unit 730 compares an ID of the serving BS with an ID of the target BS and identifies if the two BSs are the same BS. In another example, the BS determining unit 730 can determines if the two BSs are the same BS through a neighbor BS information message (i.e., a NBR-ADV message) received from the serving BS. In a further example, the BS determining unit 730 may determines if the two BSs are the same BS through a multi carrier information message (i.e., a MC-ADV message) received from the serving BS. In yet another example, the BS determining unit 730 may determine if the two BSs are the same BS through a carrier configuration information message (i.e., a CC-ADV message) received from the serving BS.

The transmitting unit 740 includes a message generator 741, an encoder 743, an OFDM modulator 745, a Digital to Analog Converter (DAC) 747, and an RF processor 749.

The message generator 741 generates a control message for handover according to the control of the controller 720. For example, the message generator 741 generates a RNG-REQ signal including intra-BS inter-frequency handover information and a CMAC according to the control of the controller 720. At this time, the message generator 741 adds the intra-BS inter-frequency handover information to the RNG-REQ signal using the last bit of a ranging purpose indication field of the RNG-REQ signal. Here, the CMAC included in the RNG-REQ signal denotes a CMAC generated using authentication information having been used for communication with the serving BS. At this time, the CMAC included in the RNG-REQ signal can be generated in the controller 720 or a separate CMAC generating module.

The encoder 743 encodes and modulates transmission data and a control message generated in the message generator 741 according to a corresponding modulation level.

The OFDM modulator 745 converts frequency-domain data provided from the encoder 743 into time-domain sample data (i.e., an OFDM symbol) through an Inverse Fast Fourier Transform (IFFT).

The DAC 747 converts the sample data provided from the OFDM modulator 745 into an analog signal. The RF processor 749 converts the baseband analog signal provided from the DAC 747 into a high frequency signal.

In the aforementioned exemplary embodiment, an MS is constructed to compare an ID of a serving BS with an ID of a target BS and determine if it is to perform intra-BS inter-frequency handover. In another exemplary embodiment, the MS may be constructed to determine if it is to perform intra-BS inter-frequency handover in a target BS. In this case, the MS does not include the BS determining unit 730. Also, the message generator 741 generates a RNG-REQ signal including a CMAC and ID information of a serving BS. Here, the CMAC included in the ranging request signal denotes a CMAC that is generated based on ID information of a target BS.

The following description is made for a construction of a BS for authenticating an MS performing handover.

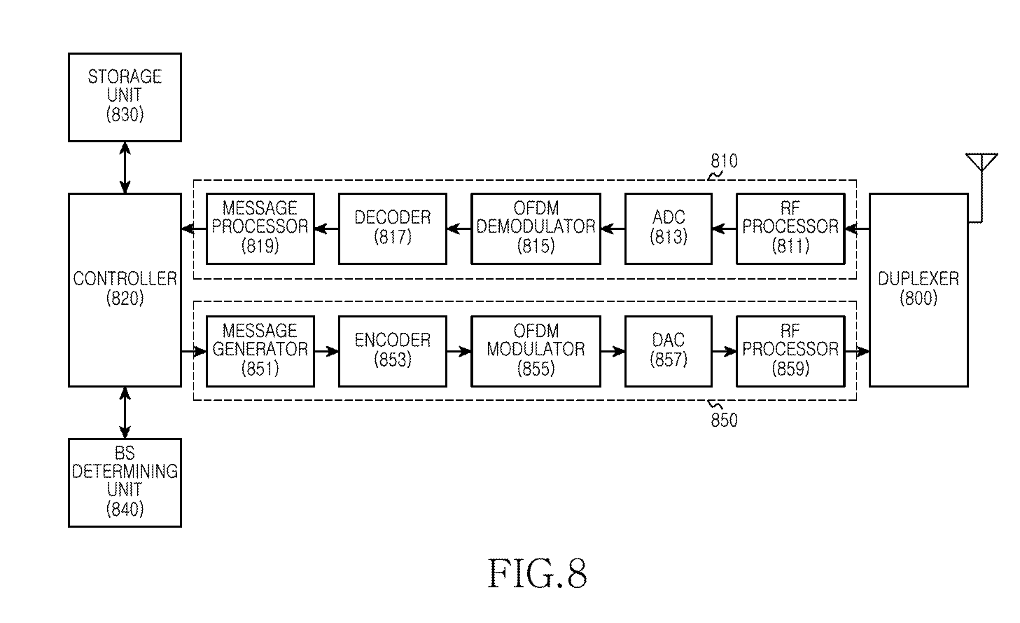

FIG. 8 illustrates a construction of a BS according to an exemplary embodiment of the present invention.

Referring to FIG. 8, the BS includes a duplexer 800, a receiving unit 810, a controller 820, a storage unit 830, a BS determining unit 840, and a transmitting unit 850.

According to a duplexing scheme, the duplexer 800 transmits a transmit signal received from the transmitting unit 850 through an antenna, and provides a receive signal from the antenna to the receiving unit 810.

The receiving unit 810 includes an RF processor 811, an ADC 813, an OFDM demodulator 815, a decoder 817, and a message processor 819.

The RF processor 811 converts a high frequency signal provided from the duplexer 800 into a baseband analog signal. The ADC 813 converts the analog signal provided from the RF processor 811 into digital sample data.

The OFDM demodulator 815 converts time-domain digital sample data provided from the ADC 813 into frequency-domain data through FFT.

The decoder 817 selects data of subcarriers intended for actual reception among the frequency-domain data provided from the OFDM demodulator 815. After that, the decoder 817 demodulates and decodes the selected data according to a predefined modulation level.

The message processor 819 extracts control information from a signal provided from the decoder 817 and transmits the control information to the controller 820. For example, the message processor 819 extracts a CMAC generated by an MS and intra-BS inter-frequency handover information of the MS from a ranging request signal provided from the decoder 817, and transmits the extracted CMAC and intra-BS inter-frequency handover information to the controller 820.

The controller 820 controls access of an MS attempting handover. For example, in a case where the controller 820 receives a ranging code from the MS attempting handover, the controller 820 controls to transmit a ranging code response to the MS.

The controller 820 performs authentication of the MS to transmit a ranging request signal considering information received from the BS determining unit 840. For example, in a case where the BS determining unit 840 determines that the MS is to perform intra-BS inter-frequency handover, the controller 820 determines the effectiveness of the CMAC included in the ranging request signal using the previous authentication information of the MS stored in the storage unit 830. Here, the previous authentication information of the MS denotes authentication information having been used when a serving BS of the MS authenticates the MS. Also, the authentication information includes AK information (i.e., an AK context). In another example, in a case where the BS determining unit 840 determines that the MS is not to perform the intra-BS inter-frequency handover, the controller 820 determines the effectiveness of the CMAC included in the ranging request signal using the authentication information of the MS acquired from an authenticator.

The storage unit 830 stores authentication information on an MS that the BS itself authenticates.

The BS determining unit 840 determines if the MS is to perform the intra-BS inter-frequency handover. For example, the BS determining unit 840 can determine if the MS is to perform the intra-BS inter-frequency handover based on a ranging purpose indication field value of the ranging request signal received from the MS. In another example, the BS determining unit 840 determines an ID of the serving BS of the MS in the ranging request signal received from the MS. After that, the BS determining unit 840 compares its own ID with the ID of the serving BS of the MS and determines if itself and the serving BS of the MS are the same BS. At this time, in a case where the BS determines that it and the serving BS of the MS are the same BS, the BS determining unit 840 recognizes that the MS is to perform the intra-BS inter-frequency handover.

The transmitting unit 850 includes a message generator 851, an encoder 853, an OFDM modulator 855, a DAC 857, and an RF processor 859.

The message generator 851 generates a control message for handover according to the control of the controller 820. For example, in a case where the MS is to perform the intra-BS inter-frequency handover, the message generator 851 generates a RNG-RSP signal including the CMAC generated using the previous authentication information of the MS. In another example, in a case where the MS is not to perform the intra-BS inter-frequency handover, the message generator 851 generates a RNG-RSP signal including a CMAC generated using authentication information of the MS acquired from the authenticator. At this time, the CMAC included in the ranging response signal can be generated in the controller 820 or a separate CMAC generating module.

The encoder 853 encodes and modulates transmission data and a control message generated in the message generator 851 according to a corresponding modulation level.

The OFDM modulator 855 converts frequency-domain data provided from the encoder 853 into time-domain sample data (i.e., an OFDM symbol) through IFFT.

The DAC 857 converts the sample data provided from the OFDM modulator 855 into an analog signal. The RF processor 859 converts the baseband analog signal provided from the DAC 857 into a high frequency signal.

The BS further includes a wired interface, although not illustrated, for communicating with the authenticator. That is, the BS acquires authentication information of an MS from the authenticator via the wired interface.

As described above, exemplary embodiments of the present invention have an advantage that, in a case where an MS is to perform intra-BS inter-frequency handover, a BS determines accessibility or non-accessibility for the MS using previous authentication information of the MS, thereby being able to reduce a handover delay of the MS in a wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for supporting handover of a Mobile Station (MS) in a multi carrier Base Station (BS) of a wireless communication system, the method comprising:
if a ranging request signal is received from the MS attempting access through a handover, determining if the BS and a serving BS of the MS are the same BS based on the ranging request signal; and
if the BS and the serving BS are the same BS, determining the effectiveness of a Cipher-based Message Authentication Code (CMAC) comprised in the ranging request signal using previous authentication information of the MS,
wherein the serving BS denotes a BS from which the MS has been serviced before the handover, and
wherein the previous authentication information of the MS denotes authentication information that the serving BS has used for authenticating the MS.

2. The method of claim 1, wherein the determining if the BS and the serving BS are the same BS comprises:
determining if the MS is to perform intra-BS inter-frequency handover based on the ranging request signal; and
determining if the BS and the serving BS are the same BS depending on whether the MS is to perform the intra-BS inter-frequency handover,
wherein the intra-BS inter-frequency handover denotes handover of the MS between two different frequencies managed by one BS.

3. The method of claim 1, wherein the determining if the BS and the serving BS are the same BS comprises:
determining IDentifier (ID) information of the serving BS included in the ranging request signal;
comparing ID information of the BS with the ID information of the serving BS; and
determining if the BS and the serving BS are the same BS.

4. The method of claim 1, further comprising:
if the CMAC is effective, generating a CMAC using the previous authentication information of the MS; and
transmitting a ranging response signal comprising the CMAC to the MS.

5. The method of claim 1, further comprising:
if the BS and the serving BS are not the same BS, acquiring authentication information on the MS from an authenticator; and
determining the effectiveness of the CMAC comprised in the ranging request signal using the authentication information acquired from the authenticator.

6. The method of claim 5, further comprising:
if the CMAC is effective, generating a CMAC using the authentication information acquired from the authenticator; and
transmitting a ranging response signal comprising the CMAC to the MS.

7. A method for handover of a Mobile Station (MS) in a wireless communication system, the method comprising:
when the MS is to perform handover from a serving Base Station (BS) to a target BS, determining if the serving BS and the target BS are the same BS;
if the serving BS and the target BS are the same BS, generating a Cipher-based Message Authentication Code (CMAC) using authentication information having been used for communication with the serving BS; and
transmitting a ranging request signal comprising the CMAC and information representing that the serving BS and the target BS are the same BS, to the target BS.

8. The method of claim 7, wherein the determining if the serving BS and the target BS are the same BS comprises:
comparing an IDentifier (ID) of the serving BS with an ID of the target BS; and
determining if the serving BS and the target BS are the same BS.

9. The method of claim 7, wherein the determining if the serving BS and the target BS are the same BS comprises:
determining if the serving BS and the target BS are the same BS based on any one of a NeighBoR ADVertisement message (NBR-ADV), a Multi-Carrier ADVertisement message (MC-ADV), and a Carrier Configuration ADVertisement message (CC-ADV) received from the serving BS.

10. The method of claim 7, wherein the information representing that the serving BS and the target BS are the same BS comprises information representing whether the MS will perform intra-BS inter-frequency handover, and
wherein the intra-BS inter-frequency handover denotes handover between two different frequencies managed by one BS.

11. An apparatus for supporting handover of a Mobile Station (MS) in a multi carrier Base Station (BS) of a wireless communication system, the apparatus comprising:
a receiving unit for receiving a signal;
a BS determining unit for, if a ranging request signal is received from the MS attempting access through a handover, determining if the BS and a serving BS of the MS are the same BS based on the ranging request signal; and
a controller for, if the BS and the serving BS are the same BS, determining the effectiveness of a Cipher-based Message Authentication Code (CMAC) comprised in the ranging request signal using previous authentication information of the MS,
wherein the serving BS denotes a BS from which the MS has been serviced before the handover, and
wherein the previous authentication information of the MS denotes authentication information that the serving BS has used for authenticating the MS.

12. The apparatus of claim 11, wherein the BS determining unit determines if the MS is to perform intra-BS inter-frequency handover based on the ranging request signal, and determines if the BS and the serving BS are the same BS depending on whether the MS is to perform the intra-BS inter-frequency handover, and
wherein the intra-BS inter-frequency handover denotes handover of the MS between two different frequencies managed by one BS.

13. The apparatus of claim 11, wherein the BS determining unit compares IDentifier (ID) information of the BS with ID information of the serving BS determined in the ranging request signal, and determines if the BS and the serving BS are the same BS.

14. The apparatus of claim 11, further comprising a transmitting unit for, if the CMAC is effective in the controller, generating a CMAC using the previous authentication information of the MS, and transmitting a ranging response signal comprising the CMAC to the MS.

15. The apparatus of claim 11, further comprising a storage unit for storing the previous authentication information of the MS,
wherein, if the BS and the serving BS are the same BS, the controller determines the effectiveness of the CMAC comprised in the ranging request signal using the previous authentication information of the MS stored in the storage unit.

16. The apparatus of claim 11, further comprising a wired interface for communicating with an authenticator,
wherein, if the BS and the serving BS are not the same BS, the controller determines the effectiveness of the CMAC comprised in the ranging request signal using authentication information on the MS acquired from the authenticator through the wired interface.

17. The apparatus of claim 16, further comprising a transmitting unit for, if the CMAC is effective in the controller, generating a CMAC using the authentication information acquired from the authenticator, and for transmitting a ranging response signal comprising the CMAC to the MS.

18. An apparatus for handover of a Mobile Station (MS) in a wireless communication system, the apparatus comprising:
a BS determining unit for, when the MS is to perform handover from a serving Base Station (BS) to a target BS, determining if the serving BS and the target BS are the same BS; and
a transmitting unit for, if the serving BS and the target BS are the same BS, generating a Cipher-based Message Authentication Code (CMAC) using authentication information having been used for communication with the serving BS, and for transmitting a ranging request signal comprising the CMAC and information representing that the serving BS and the target BS are the same BS, to the target BS.

19. The apparatus of claim 18, wherein the BS determining unit compares an IDentifier (ID) of the serving BS with an ID of the target BS and determines if the serving BS and the target BS are the same BS.

20. The apparatus of claim 18, further comprising a receiving unit for receiving a signal,
wherein the BS determining unit determines if the serving BS and the target BS are the same BS based on any one of a NeighBoR ADVertisement message (NBR-ADV), a Multi-Carrier ADVertisement message (MC-ADV), and a Carrier Configuration ADVertisement message (CC-ADV) received from the serving BS through the receiving unit.
